(19) United States
(12) Patent Application Publication
(10) Pub. No.: US 2013/0139687 A1
(43) Pub. Date: Jun. 6, 2013

(54) METHOD FOR THE REMOVAL OF ACID GASES FROM A RESIDUAL GAS OF AN ALCOHOL SYNTHESIS

(71) Applicant: Linde Aktiengesellschaft, Munchen (DE)

(72) Inventors: Horst WEISS, Munchen (DE); Anna Maria FISCHER, Munchen (DE)

(73) Assignee: LINDE AKTIENGESELLSCHAFT, MUNCHEN (DE)

(21) Appl. No.: 13/705,358

(22) Filed: Dec. 5, 2012

(30) Foreign Application Priority Data
Dec. 6, 2011 (DE) 102011120398.6

(51) Int. Cl. B01D 53/14

(52) U.S. Cl. CPC B01D 53/1493
USPC 95/171; 95/236; 95/186; 95/159

(57) ABSTRACT

The invention relates to a method for separating off carbon dioxide from a gas mixture containing hydrogen, carbon monoxide and carbon dioxide, which gas mixture is produced as residual gas in an alcohol synthesis. The residual gas is subjected to a physical gas scrubbing in which carbon dioxide is scrubbed out of the residual gas in an absorption step by means of a low-temperature alcohol used as the scrubbing medium.

### SUMMARY OF THE INVENTION

The invention relates to a method for removing carbon dioxide from a gas mixture containing hydrogen, carbon monoxide and carbon dioxide, wherein the gas mixture is produced as a residual gas in an alcohol synthesis, and removal of carbon dioxide is achieved by subjecting the residual gas to gas scrubbing.

Alcohols such as ethanol, propanol, butanol and, in particular, methanol, are synthesized on an industrial scale from hydrogen and carbon monoxide or carbon dioxide. For this purpose, a sulphur-free synthesis gas containing hydrogen, carbon monoxide and carbon dioxide is introduced into a synthesis circuit at a pressure which is typically between 40 and 150 bar, and in the synthesis circuit an alcohol-containing product stream is generated with catalytic support. By condensing out the alcohols formed, and also the water formed in the synthesis, unreacted gas components are separated off from the product stream and predominantly returned to the synthesis circuit. A small part of the unreacted gas components is ejected as residual gas in order to prevent enrichment in the synthesis circuit of starting materials present in excess, as well as substances such as methane or nitrogen which are inert under the conditions of the alcohol synthesis. Usually, the pressure at which the residual gas is produced is only a little lower than the pressure at which the synthesis gas is introduced into the synthesis circuit.

Although the residual gas contains valuable hydrogen and also carbon monoxide, owing to its carbon dioxide content it cannot be fed to direct material utilization and is therefore used, in the prior art, for firing a reformer used for generating synthesis gas. In order to utilize the residual gas materially, a marked reduction of its carbon dioxide content is necessary, for which purpose amine scrubbers are suitable, as have been used in the prior art and known to those skilled in the art for many years.

Amine scrubbers, because of their simple structure, may be implemented with relatively low capital costs. However, their operation poses some problems which can have adverse effects on their economic efficiency. The adverse effects which may be mentioned here are primarily the strong corrosive action, the risk of foaming, the instability of the scrubbing media used, the large losses of scrubbing medium and also the high heat requirement which is necessary for scrubbing medium regeneration.

Therefore, an aspect of the present invention is to provide a method of the type described above in which a residual gas produced in an alcohol synthesis can be treated, in an economic manner, so that it can be materially utilized.

Upon further study of the specification and appended claims, other aspects and advantages of the invention will become apparent.

These aspects are achieved, according to the invention, by scrubbing carbon out of the residual gas by means of a physical gas scrubbing wherein a low-temperature alcohol is used as the scrubbing medium.

As is the case of amine scrubbing, physical gas scrubbing stages has long been known in the prior art and used in industry for removing gas components from gas mixtures. These physical gas scrubbing stages exploit the property of liquids to absorb gaseous substances and keep them in solution, without chemically binding these substances.

By removing the gas components that are separated off from the gas mixture and dissolved in the scrubbing medium, the loaded scrubbing medium is regenerated, for example, subsequent to being recycled to the gas scrubbing. Usually, the regenerated scrubbing medium is again used for gas scrubbing, while the gas components that are separated off are either disposed of or fed to an economic utilization.

For purification of crude synthesis gases that are generated on an industrial scale in gasification plants from coal- and/or hydrocarbon-containing feedstocks, for example by reforming with hydrogen or by partial oxidation, and which, generally, in addition to the desired substances hydrogen and carbon monoxide, also contain undesirable constituents such as carbon dioxide and sulphur components (e.g., hydrogen sulphide and carbonyl sulphide), preferably physical scrubbers are used.

The use of physical scrubbers is typical because the crude synthesis gases are usually generated at high pressure, and the effectiveness of physical scrubbing, to a first approximation, increases linearly with the operating pressure. Methanol scrubbing is of particular importance for the purification of crude synthesis gases. Methanol scrubbing exploits the fact that the solubility coefficients of sulphur components and carbon dioxide with respect to methanol differ greatly from those of hydrogen and carbon monoxide. Since with decreasing temperature, these differences increase and therefore the hydrogen and carbon monoxide losses due to co-absorption decrease, especially because the solubility coefficient of carbon dioxide increases greatly with falling temperature, the methanol scrubbing medium is usually introduced into a scrubbing column at a temperature far below 0° C. and brought into intense contact with the synthesis gas that is to be purified. Furthermore, this method permits an independent production of sulphur components and of carbon dioxide, since the sulphur components have considerably greater solubility coefficients than the carbon dioxide and therefore can be largely selectively separated off from the loaded methanol scrubbing medium in an at least two-stage scrubbing process.

At least the sulphur components can be used as feed for processes outside the boundaries of the installation for the purification of the crude synthesis gases, whereby the disadvantages of a methanol scrubbing stage which result, especially, from the complex structure thereof and also the necessity for external supply of refrigeration, are balanced. Although the residual gas from an alcohol synthesis is present at high pressure, treatment thereof in a standard methanol scrubber is therefore only conditionally suitable since, because it is free of sulphur components, it does not have the advantage of producing sulphur components for material utilization. A typical pressure range of the residual gas obtained from methanol synthesis is 50 to 90 bar (a).

In order to ensure the economic efficiency of the residual gas treatment according to the invention, it is proposed to carry out the physical gas scrubbing, which is preferably a methanol scrubbing, as simply as possible. Expediently, the gas scrubbing therefore only comprises one absorption step in which carbon dioxide is scrubbed out of the residual gas in a one-stage scrubbing process, preferably at temperatures between −40 and −10° C. The residual gas, for this purpose, is preferably conducted through an absorption column in countercurrent to the scrubbing medium used. From the top of the absorption column, a gas mixture predominantly consisting of hydrogen and carbon monoxide can be removed, and from the bottom thereof, a scrubbing medium loaded with carbon dioxide can be removed. The gas mixture is subsequently warmed against residual gas that is to be cooled, while the loaded scrubbing medium is expediently regenerated by separating off absorbed substances and then is reused as scrubbing medium in the scrubbing process, and so a scrubbing medium circuit is formed.

An embodiment of the method according to the invention provides that loaded scrubbing medium, for regeneration, is expanded into a stripping column to a pressure between 1 and 8 bar (a), in which absorbed substances are expelled using a stripping gas. Preferably, further regeneration measures such as, for example, the warming of the scrubbing medium that is to be regenerated, are dispensed with. Before being sent to the stripping column, the loaded scrubbing medium can optionally be expanded into a container designed as a separator to an intermediate pressure (for example, 5 to 35 bar (a)) in order to separate off co-absorbed hydrogen and carbon monoxide and return them upstream of the scrubbing process into the residual gas that is to be treated. The substances separated off in the stripping column from the loaded scrubbing medium are warmed against residual gas that is to be cooled, together with the stripping gas which is expediently nitrogen, and disposed of, for example in a flare. If the concentrations of environmentally-hazardous substances do not exceed the legal limiting values, direct release into the atmosphere is also possible.

In order to avoid enrichment in the scrubbing medium circuit of trace components that are present in the residual gas of the synthesis, which trace components preferentially dissolve in the scrubbing medium and which cannot be separated off from the loaded scrubbing medium in the regeneration, or are only separated off inadequately, a further embodiment of the method according to the invention provides that some of the scrubbing medium is taken off from the scrubbing medium circuit and replaced by fresh scrubbing medium.

Particularly advantageously, the method according to the invention can be performed using, as scrubbing medium in the gas scrubbing, an alcohol that is also generated in the alcohol synthesis. For example, in such a case, it is then possible to materially utilize scrubbing medium removed from the scrubbing medium circuit by introducing it into the alcohol synthesis for treatment.

To cover the losses in refrigeration, alcohol synthesis processes are usually equipped with an external refrigeration plant. Because of the low operating temperatures of a physical gas scrubbing stage used according to the invention, here also, refrigeration losses unavoidably occur which must be compensated for by external refrigeration. In order to keep the costs of the method according to the invention low, it is proposed to obtain the external refrigeration required for the gas scrubbing from an external refrigeration plant which simultaneously is also used for the external refrigeration supply of the alcohol synthesis in which the residual gas that is to be treated is produced.

Owing to simplicity of the physical gas scrubbing proposed, the residual gas produced in an alcohol synthesis can be economically prepared for material utilization without the known disadvantages of an amine scrubbing having to be accepted.

### BRIEF DESCRIPTION OF THE DRAWINGS

The invention as well as further advantages, features and examples of the present invention are explained in more detail by the following descriptions of embodiments based on the Figures, wherein:

FIG. 1 schematically shows an exemplary embodiment in accordance with the invention.

FIG. 1 shows a methanol scrubbing in which carbon dioxide is separated off from the residual gas of an alcohol synthesis.

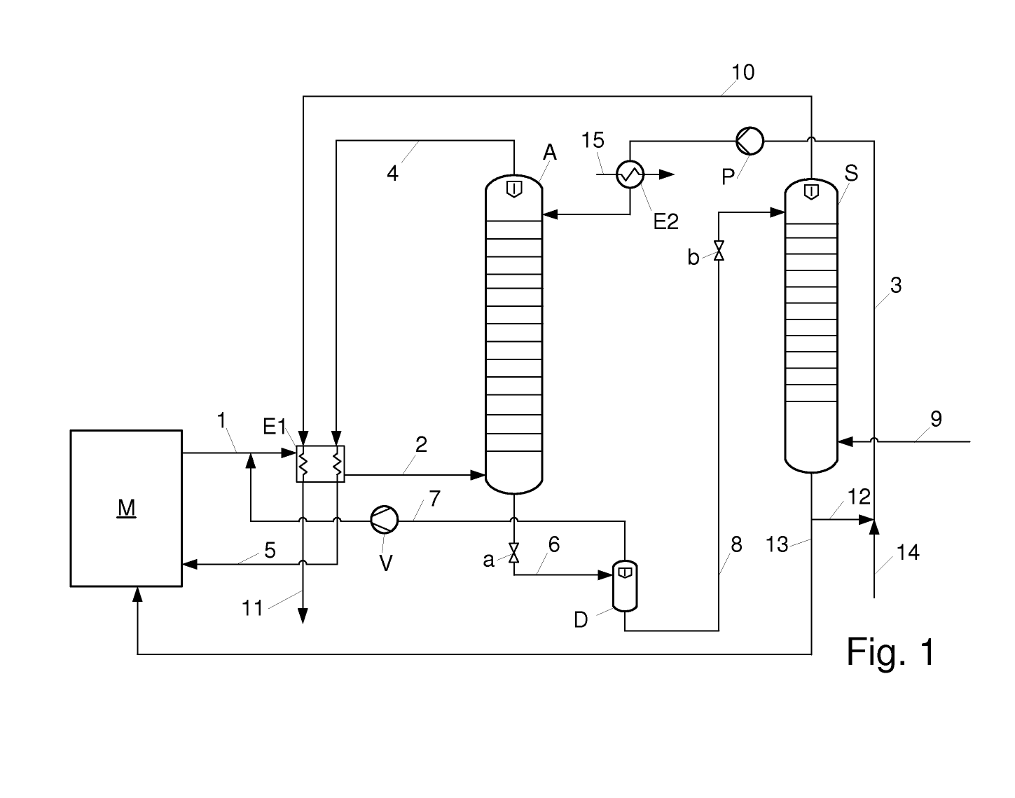

From the alcohol synthesis M, which is, for example, methanol synthesis, the sulphur-free residual gas 1 containing hydrogen, carbon monoxide and carbon dioxide is taken off and cooled in the heat exchanger E1 against process streams that are to be warmed. The cooled residual gas is introduced via line 2 into the lower part of the absorber column A in which it is then conducted upwards. At the top of the absorber column A, a low-temperature liquid methanol stream is introduced as scrubbing medium that, on its path downwards, is brought into intense contact with the residual gas that is conducted in countercurrent and, in this case, predominantly absorbs carbon dioxide. Via line 4, therefore, a substantially carbon dioxide-free gas mixture can be removed that predominantly consists of hydrogen and carbon monoxide. After warming against the residual gas 1 that is to be cooled in the heat exchanger E1, this gas is supplied as feed to the alcohol synthesis M via line 5 for material utilization. It is also conceivable to supply this gas to another use.

From the bottom of the absorber column A, scrubbing medium 6, loaded with carbon dioxide but also with co-absorbed hydrogen and carbon monoxide, can be removed and expanded via the throttling element (e.g., a throttle valve) a into the separator D to a pressure at which especially hydrogen and carbon dioxide pass into the gas phase. The resultant gas phase is subsequently returned via line 7, using the compressor V, into the residual gas 1 that is to be treated. The liquid phase 8 from the separator D which contains the majority of the carbon dioxide absorbed in the absorber column A is expanded via the throttling element b to a pressure between 1 and 8 bar (a) and introduced into the upper part of the stripping column S. Via line 9, nitrogen serving as stripping gas is introduced into the lower part of the stripping column S in order to separate off the absorbed substances as completely as possible from the scrubbing medium flowing downwards. From the top of the stripping column S, therefore, a gas mixture 10, predominantly consisting of nitrogen and carbon dioxide, can be removed, which, after warming against the residual gas 1 that is to be cooled in the heat exchanger E1 can be released into the atmosphere, for example, via line 11.

The regenerated scrubbing medium 12 removed from the bottom of the stripping column S already substantially meets scrubbing medium quality, but still contains trace components that are difficult to separate off. In order to prevent enrichment of the trace components, a part 13 of the regenerated scrubbing medium is branched off and replaced by fresh methanol 14 that is fed from outside the boundaries of the installation, in such a manner that a scrubbing medium stream 3 is formed. Whereas the stream 13 that is branched off is introduced into the alcohol synthesis M for material utilization, the scrubbing medium 3 is returned to the absorber column A using the pump P. In the heat exchanger E2, heat is removed from the scrubbing medium 3 by external refrigeration 15, in such a manner that the scrubbing medium can be applied at the top of the absorber column A at operating temperature.

The invention shall be further illustrated by the following numerical example:

A residual gas, which is produced in a methanol synthesis plant at a volumetric flow rate of 72,000 m_{N}³/h, a pressure of 90 bar (a), a temperature of 40° C. and a carbon dioxide content of 4 mol %, is precooled against process streams that are to be warmed and is introduced at a temperature of −20° C. into the absorber column. At the top of the absorber column, approximately 100 m_{N}³/h of methanol are introduced at a temperature of −35° C., via which the carbon dioxide present in the residual gas is scrubbed out down to 0.5 mol %. The loaded scrubbing medium from the bottom of the scrubbing column is expanded to 30 bar (a) and the resultant liberated gas phase is recompressed into the warm residual gas. Subsequently, the loaded scrubbing medium is further expanded to 2 bar (a) and conducted to the top of the stripping column. There, the carbon dioxide is substantially stripped off from the scrubbing medium at a temperature level of −25° C. with approximately 2500 m_{N}³/nitrogen. The stripping medium from the bottom of the stripping column is cooled via a heat exchanger for cooling using an externally supplied coolant and pumped back at −40° C. to the top of the scrubbing column. The gases taken off overhead from the scrubbing and stripping columns are warmed to 30° C. against the incoming residual gas. For avoiding an enrichment of minor components that are highly soluble in the methanol, such as, for example, higher alcohols, a substream of the order of magnitude of 1% is taken off from the stripped scrubbing medium and conducted to a point outside the boundaries of the installation. Small scrubbing medium losses are compensated for by addition of fresh methanol.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German patent application No. 10 2011 120 398.6, filed Dec. 6, 2011, are incorporated by reference herein.

1. A method for separating off carbon dioxide from a gas mixture containing hydrogen, carbon monoxide and carbon dioxide, which gas mixture is produced as residual gas in an alcohol synthesis, comprising:
subjecting said residual gas is to a physical gas scrubbing in which carbon dioxide is scrubbed out of said residual gas in an absorber by means of a low-temperature alcohol used as scrubbing medium.

2. The method according to claim 1, wherein scrubbing medium that is loaded with carbon dioxide in the physical gas scrubbing is regenerated and subsequently used in the absorber as scrubbing medium.

3. The method according to claim 2, wherein a portion of the scrubbing medium is ejected and replaced by fresh scrubbing medium.

4. The method according to claim 3, wherein the ejected scrubbing medium is fed to the alcohol synthesis.

5. The method according to claim 1, wherein an alcohol is generated in the alcohol synthesis is used as said scrubbing medium.

6. The method according to claim 1, wherein methanol is used as said scrubbing medium.

7. The method according to claim 1, wherein scrubbing medium that is loaded with carbon dioxide in the physical gas scrubbing is regenerated by expansion into a stripping column wherein carbon dioxide is removed using a stripping gas.

8. The method according to claim 7, wherein nitrogen is used as said stripping gas.

9. The method according to claim 1, wherein external refrigeration is provided from an external refrigeration plant that is also used for providing refrigeration for the alcohol synthesis.

10. The method according to claim 1, the absorber operates at a pressure between 1 and 8 bar (a).
